(19) United States
(12) Patent Application Publication
(10) Pub. No.: US 2026/0026920 A1
(43) Pub. Date: Jan. 29, 2026

(54) A METHOD FOR PROCESSING IMAGE, AN ELECTRONIC APPARATUS AND A COMPUTER READABLE STORAGE MEDIUM

(71) Applicant: MEDIT CORP., Seoul (KR)

(72) Inventor: Jin Young KIM, Seoul (KR)

(21) Appl. No.: 18/994,009

(22) PCT Filed: Jul. 13, 2023
(86) PCT No.: PCT/KR2023/010062

§ 371 Date: Jan. 13, 2025

(30) Foreign Application Priority Data
Jul. 13, 2022 (KR) 10-2022-0086432
Jul. 12, 2023 (KR) 10-2023-0090640

(51) Int. Cl. A61C 13/00; G06T 7/00

(52) U.S. Cl. CPC A61C 13/0004; G06T 7/0012; G06T 2207/30036

(57) ABSTRACT

A method for processing an image, an electronic apparatus performing the same, and a computer readable storage medium storing the same are provided. The method for processing an image includes receiving at least one intraoral image, calculating based on an area of at least a portion of scan data corresponding to the at least one intraoral image, and displaying a final prosthesis insertion direction for the scan data based on the calculating.

### TECHNICAL FIELD

The present disclosure relates to a method for processing an image, an electronic apparatus, and a computer readable storage medium.

### BACKGROUND ART

Prostheses (splints, temporary teeth, etc.) that are inserted and arranged in an oral cavity may be used to treat temporomandibular joint disorders, dental trauma, cavities, gum disease, etc. In order to manufacture the prostheses by reflecting the characteristics of the oral cavity into which they are inserted, intraoral images obtained by scanning the oral cavity are utilized in the manufacturing of the prostheses.

In order to insert the prosthesis into the mouth or to maintain the prosthesis inserted into the mouth, an undercut region of tooth that does not contact the prosthesis should be considered depending on a prosthesis insertion direction.

There is the hassle of having to determine a block-out direction to reduce the undercut effect each time the prosthesis is made, and since the retention power of the prosthesis may vary depending on the block-out direction, there is a problem that it is difficult to make a prosthesis with uniform retention power for a plurality of oral cavities.

### DISCLOSURE

### Technical Problem

The present disclosure attempts to provide a prosthesis model having uniform retention force for a plurality of oral cavities while reducing the influence of undercuts.

The present disclosure attempts to increase the efficiency of manufacturing a plurality of prostheses while reducing the influence of undercuts.

The present disclosure attempts to determine a prosthesis insertion direction by considering an undercut region according to an insertion of the prosthesis, such as a black triangle, thereby increasing the convenience of a patient and a user.

### Technical Solution

According to an exemplary embodiment, a method for processing an image includes receiving at least one intraoral image, calculating based on an area of at least a portion of scan data corresponding to the at least one intraoral image, and displaying a final prosthesis insertion direction for the scan data based on the calculating.

According to another exemplary embodiment, an electronic apparatus includes a user interface device, a processor, and a memory storing instructions executable by the processor, in which the processor executes the instructions to receive at least one intraoral image, calculate based on an area of at least a portion of scan data corresponding to the at least one intraoral image, and display a final prosthesis insertion direction for the scan data based on the calculation operation.

According to still another exemplary embodiment, there is provided a computer readable storage medium including computer readable instructions, in which the instructions cause the computer to receive at least one intraoral image, calculate based on an area of at least a portion of scan data corresponding to the at least one intraoral image, and display a final prosthesis insertion direction for the scan data based on the calculating.

According to the disclosed exemplary embodiments, it is possible to provide the plurality of prosthesis models having uniform retention power.

According to the disclosed exemplary embodiments, it is possible to increase the efficiency of manufacturing the plurality of prostheses while reducing the influence of undercuts.

According to the disclosed exemplary embodiments, it is possible to determine the prosthesis insertion direction by reflecting the undercut according to the black triangle, etc., thereby increasing the convenience of the patient and the user.

### DESCRIPTION OF THE DRAWINGS

FIG. 1 is a diagram for describing an image processing system including an electronic apparatus according to an exemplary embodiment.

FIG. 2 is a block diagram illustrating a configuration of an electronic apparatus according to an exemplary embodiment.

FIG. 3 is a flowchart illustrating a method for processing an image of an electronic apparatus according to an exemplary embodiment.

FIGS. 4 and 5 are diagrams for describing scan data, maxillary scan data, and mandibular scan data according to an exemplary embodiment.

FIG. 6 is a flowchart illustrating a method for processing an image of an electronic apparatus according to an exemplary embodiment.

FIG. 7 is a diagram for describing a step of extracting a tooth region according to an exemplary embodiment.

FIG. 8 is a diagram for describing a step of setting a prosthesis insertion direction according to an exemplary embodiment.

FIG. 9 is a diagram for describing a step of calculating an anterior undercut area according to an exemplary embodiment.

FIG. 10 is a diagram for describing a step of displaying and determining a final prosthesis insertion direction according to an exemplary embodiment.

### MODE FOR INVENTION

Hereinafter, exemplary embodiments of the present disclosure will be described in detail with reference to the accompanying drawings so that those skilled in the art to which the present disclosure pertains may easily practice the present disclosure. The present disclosure may be implemented in various different forms and is not limited to exemplary embodiments provided herein.

Portions unrelated to the description will be omitted in order to obviously describe the present disclosure, and similar components will be denoted by the same reference numerals throughout the present specification.

In addition, the size and thickness of each component illustrated in the drawings are arbitrarily indicated for convenience of description, and the present disclosure is not necessarily limited to the illustrated those. In the drawings, the thickness of layers, films, panels, regions, etc., are exaggerated for clarity. In addition, in the accompanying drawings, thicknesses of some of layers and regions have been exaggerated for convenience of explanation.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, when an element is referred to as being “on” a reference element, it can be positioned on or beneath the reference element, and is not necessarily positioned on the reference element in an opposite direction to gravity.

In addition, unless explicitly described to the contrary, the word “comprise”, and variations such as “comprises” or “comprising”, will be understood to imply the inclusion of stated elements but not the exclusion of any other elements.

Further, throughout the specification, the word “plane” refers to a view when a target is viewed from the top, and the word “cross section” refers to a view when a cross section of a target taken along a vertical direction is viewed from the side.

In addition, terms including an ordinal number such as first, second, or the like, used in the present disclosure may be used to describe various components. However, these components are not limited to these terms. The above terms are used solely for the purpose of distinguishing one component from another.

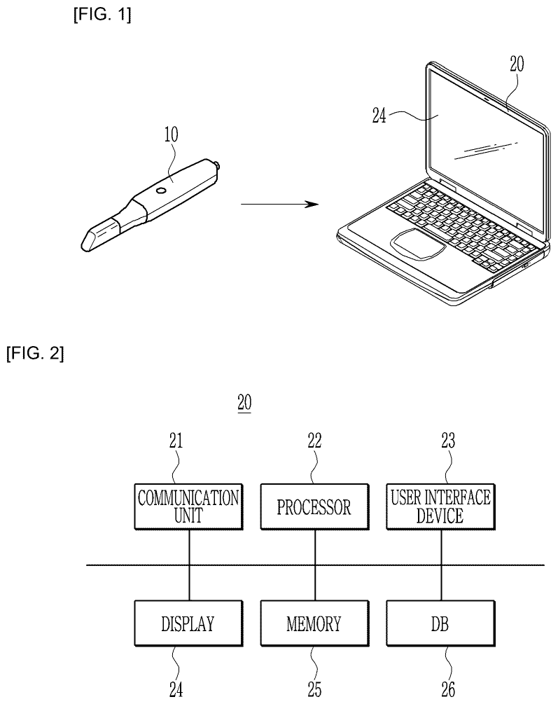

FIG. 1 is a diagram for describing an image processing system including an electronic apparatus according to an exemplary embodiment. FIG. 2 is a block diagram illustrating a configuration of an electronic apparatus according to an exemplary embodiment.

Referring to FIG. 1 and FIG. 2, a system 1 for processing an image may include a scanner 10 and an electronic apparatus 20.

In this specification, an ‘object’ is a capturing subject and may include a person, an animal, or a part thereof. For example, the object may include a part (an organ, an organ, etc.) of a body, a phantom, etc. In addition, for example, the object may include a plaster model modeling an oral cavity, a denture such as a denture or a prosthesis, a dentiform in a shape of teeth, etc. For example, the object may include a tooth, a gingiva, at least a portion of the oral cavity, and/or artificial structures (e.g., an orthodontic device including bracket and wire, dental restorations including implant, abutment, artificial teeth, inlay and onlay, and orthodontic auxiliary tools inserted into the oral cavity, etc.) that may be inserted into the oral cavity, the tooth or gingiva to which the artificial structures are attached, etc.

The scanner 10 may mean a device that acquires an image related to the object. The scanner 10 may mean a scanner 10 that acquires an intraoral image related to the oral cavity used for oral treatment. The scanner 10 may acquire at least one of a two-dimensional (2D) image and a three-dimensional (3D) image. In addition, the scanner 10 may acquire at least one 2D image of the oral cavity, and generate a 3D image (or a 3D model) of the oral cavity based on at least one acquired 2D image. In addition, the scanner may acquire at least one two-dimensional image of the oral cavity, and transmit the at least one two-dimensional image to the electronic apparatus 20.

The electronic apparatus 20 may also image a surface of at least one of the scanner 10 tooth model or tooth, a gingiva, and the artificial structures (e.g., the orthodontic device including the bracket and wire, the orthodontic auxiliary tools inserted into the oral cavity including the implant, the artificial teeth, and splint, etc.) insertable into the oral cavity, and for this purpose, may acquire surface information about the object as raw data.

The electronic apparatus 20 may generate the 3D image of the oral cavity based on at least one received 2D image. Here, the ‘3D image’ may be generated by three-dimensionally modeling the object based on the received raw data, and thus may be called a ‘3D model’. In addition, in the present disclosure, a model or image representing an object two-dimensionally or three-dimensionally may be collectively called an ‘image’.

For example, the scanner 10 may be an intraoral scanner having a form that may be inserted into the oral cavity, and according to the exemplary embodiment, the intraoral scanner may be a wired device or a wireless device, and the technical idea of the present disclosure is not limited to the form of the intraoral scanner.

According to an exemplary embodiment, the intraoral scanner may be a hand-held type scanner that can be held by hand and carried. The intraoral scanner may be inserted into the oral cavity, and scan teeth in a non-contact manner to obtain an image of the oral cavity including at least one tooth, and scan the inside of the patient's oral cavity using at least one image sensor (e.g., an optical camera, etc.).

According to an exemplary embodiment, the scanner 10 may be a table type scanner that may be used for dental treatment. The table type scanner may be a scanner that acquires the surface information on an object as the raw data by scanning the object using the rotation of the table. The table scanner may scan a surface of an object such as a plaster model or an impression model modeling the oral cavity.

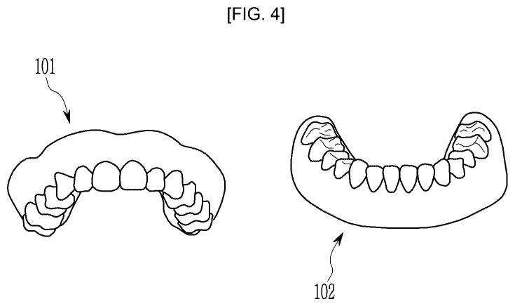

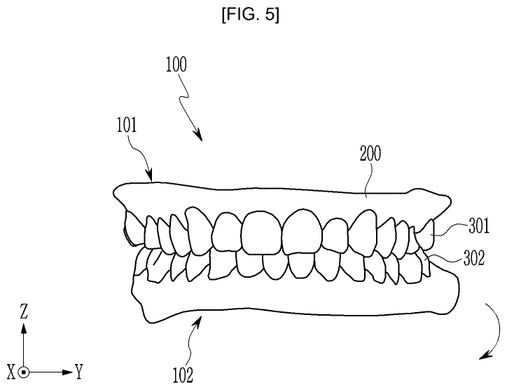

The electronic apparatus 20 may receive the raw data from the scanner 10 and process the received raw data to output a 3D image for the raw data. According to an exemplary embodiment, the output 3D image may be 3D image data including prosthesis such as the splint for the received raw data. For ease of description, a specific description of the scan data is described later with reference to FIGS. 4 and 5.

The electronic apparatus 20 may be any electronic apparatus that is connected to the scanner via a wired or wireless communication network, and may receive a 2D image acquired by scanning the object from the scanner and generate, process, display, and/or transmit an image based on the received 2D image.

The electronic apparatus 20 may store and execute dedicated software to perform at least one operation of receiving, processing, storing, and/or transmitting the 3D image or the 2D image of the object. For example, the dedicated software may perform processing operations such as region extraction and region setting on the received scan data, and perform data selection, reference point adjustment, alignment, etc., based on the processing operations to perform at least one operation such as generation, storing, and transmitting the prosthesis for the scan data as the 3D image. The electronic apparatus 20 may be a computing device such as a smart phone, a laptop computer, a desktop computer, a PDA, or a tablet PC, but is not limited thereto. In addition, the electronic apparatus 20 may exist in the form of a server (or server device) for processing oral images.

The electronic apparatus 20 may include a communication unit 21, a processor 22, a user interface device 23, a display 24, a memory 25, and a database 26. However, not all of the illustrated components are essential components. The electronic apparatus 20 may be implemented by more components than the illustrated components, or may be implemented by fewer components. The components will be described below.

The communication unit 21 may perform communication with an external device. Specifically, the communication unit 21 may be connected to a network by wire or wirelessly to perform communication with the external device. Here, the external device may be the scanner 10, a server, a smartphone, a tablet, a PC, etc.

The communication unit 21 may include a communication module that supports one of various wired and wireless communication methods. For example, the communication module may be in the form of a chipset, or may be a sticker/barcode (e.g., a sticker including an NFC tag), etc., including information necessary for communication. In addition, the communication module may be a short-range communication module or a wired communication module.

For example, the communication unit 21 may support at least one of wireless LAN, wireless fidelity, Wi-Fi direct, Bluetooth, Bluetooth low energy, wired LAN, near field communication, Zigbee, Infrared data association (IrDA), 3G, 4G, and 5G.

In an exemplary embodiment, the scanner 10 may transmit the acquired raw data to the electronic apparatus 20 through the communication module. The image data acquired by the scanner may be transmitted to the electronic apparatus 20 connected through the wired or wireless communication network.

The processor 22 controls the overall operation of the electronic apparatus 20 and may include at least one processor, such as a CPU. The processor 22 may include at least one specialized processor corresponding to each function, or may be a processor integrated into one.

The processor 22 may receive the raw data through the communication unit 21. For example, the processor 22 may receive the raw data from the scanner 10 through the communication unit 21. In this case, the processor 22 may generate the 3D image data (e.g., surface data, mesh data, etc.) that represents the shape of the surface of the object three-dimensionally based on the received raw data. Hereinafter, the scan data that becomes the calculation target of the electronic apparatus 20 may include the 3D image data.

The processor 22 may receive library data from the external device through the communication unit 21. The library data may be data pre-stored in the electronic apparatus 20 or the raw data or the 3D image data acquired through the external device, but is not limited thereto. Here, the external device may be a camera capable of capturing pictures or videos, or an electronic apparatus having a camera function. In addition, the external device may be an intraoral scanner capable of scanning the inside of a patient's mouth.

The processor 22 may control the user interface device 23 or the display 24 to receive a predetermined command or data from a user.

The processor 22 may execute a program stored in the memory 25, read an image, data, or file stored in the memory 25, or store a new file in the memory 25. The processor 22 may execute instructions stored in the memory 25. The stored program may include, but is not limited to, dedicated software.

The processor 22 may perform a calculation operation on mesh data, data, etc., included in the scan data. For example, the processor 22 may recognize the undercut region generated according to the set prosthesis insertion direction and calculate the area of the undercut region. According to an exemplary embodiment, the processor 22 may generate a setting condition based on the calculated area and perform a comparison operation.

The processor 22 may recognize an object in the scan data, extract a portion of an area, or calculate the area or volume of the recognized object or the extracted area. For example, the processor 22 may separately recognize the type (e.g., anterior teeth and posterior teeth) of teeth by using a curvature information, cusp information, etc., of the scan data, or distinguish a space between teeth. According to an exemplary embodiment, the recognition operations of the processor 22 are not limited to the examples of utilizing the information, and the recognition operations may be performed through the inference of the object recognition artificial intelligence algorithm. The cusp information may include the number and arrangement of cusp points where the molar in the scan data comes into contact.

The processor 22 may perform a compensation operation on the scan data. For example, the processor 22 may perform an operation of adding a predetermined angle in a certain direction with respect to the set prosthesis insertion direction, but is not limited to the above example.

The user interface device 23 may mean a device that receives data from a user to control the electronic apparatus 20. The display 24 may include an output device for displaying a result image according to the operation of the electronic apparatus 20 or the 3D image output from the electronic apparatus 20.

The user interface device 23 may include, for example, an input device such as a mouse, a joystick, an operation panel, a touch sensitive panel that receives user input, and the display 24 may include a display panel that displays a screen, etc.

The memory 25 may store software or a program, and the stored software or program may be dedicated software, but is not limited thereto. The memory 25 may store at least one instruction for executing the method of operating the electronic apparatus 20 that calls scan data, sets the prosthesis insertion direction for the scan data, calculates the undercut according to the set direction, and determines the prosthesis insertion direction, along with the set prosthesis insertion direction.

The database 26 may store data and a dataset for training an artificial intelligence algorithm of dedicated software, and may provide data for training according to a request of the dedicated software. The artificial intelligence algorithm may train the training data of teeth stored in the database 26 using a deep learning method and distinguish the characteristics of data representing teeth. Meanwhile, the dedicated software may use the extracted or recognized tooth region data when performing an occlusal plane alignment step, an inner setting step, an outline designation step, etc., which will be described later, by extracting maxillary tooth region data and mandibular tooth region data from scan data or recognizing objects according to tooth characteristics.

In the present disclosure, the artificial intelligence (AI) means a technology that imitates human learning ability, reasoning ability, and perception ability and implements them with a computer, and may include the concepts of machine learning and symbolic logic. The machine learning (ML) may be an algorithm technology that classifies or trains the characteristics of input data on its own. The technology of the artificial intelligence may analyze input data as the machine learning algorithm, train the results of the analysis, and make the judgment or prediction based on the results of the training. In addition, technologies that imitate the cognitive and judgment functions of the human brain by utilizing the machine learning algorithm may also be understood as part of the category of the artificial intelligence. For example, the fields of technology of linguistic understanding, visual understanding, inference/prediction, knowledge expression, and motion control may be included.

In this disclosure, the machine learning may mean a process of training a neural network model using experience in processing data. Through the machine learning, the computer software may mean improving its own data processing ability. A neural network model is constructed by modeling correlations between data, and the correlations may be expressed by multiple parameters. The neural network model extracts and analyzes features from given data to derive correlations between data, and repeats the process to optimize the parameters of the neural network model, which may be called the machine learning.

For example, the neural network model may train a mapping (correlation) between inputs and outputs for data given as input-output pairs. Alternatively, even when only the input data is given, the neural network model may derive regularities between the given data and train the relationship.

In the present disclosure, the artificial intelligence training model, the machine learning model, or the neural network model may be designed to implement a human brain structure on a computer, and may include a plurality of network nodes that simulate neurons of a human neural network and have weights. The plurality of network nodes may simulate synaptic activity of neurons that exchange signals through synapses, and thus may have a connection relationship between each other. In the artificial intelligence learning model, the plurality of network nodes may be located in layers of different depths and may exchange data according to the convolution connection relationship.

Although the database 26 is illustrated as being included in the electronic apparatus 20 in the drawing, it is not limited thereto and may be arranged in the form of a server (or server device) or the like outside the electronic apparatus 20 to provide data for training and store training results.

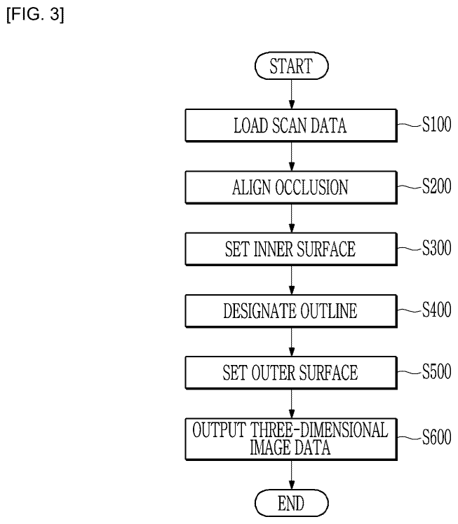

FIG. 3 is a flowchart illustrating a method for processing an image of an electronic apparatus according to an exemplary embodiment. FIGS. 4 and 5 are diagrams for describing scan data, maxillary scan data, and mandibular scan data according to an exemplary embodiment.

Referring to FIGS. 1 to 5, the electronic apparatus 20 loads scan data 100 (S100). The electronic apparatus 20 loads the scan data 100 generated based on the image received from the external device including the scanner 10, etc., through the communication unit 21.

The electronic apparatus 20 loads scan data 100 processed based on the received image or pre-stored in the processor 22 or the user interface device 23, and may display the loaded scan data 101 through the display 24.

The scan data 100 may be the 2D image of the object, the 3D model representing the object in three dimensions, or the 3D image data, and specifically, may be a 3D intraoral model. According to an exemplary embodiment, the intraoral images in FIGS. 4 and 5 correspond to the scan data 100 and are 2D or 3D expressions of the objects of the scan data 100, and may include a maxillary pre-preparation (prep) image, a maxillary prep image, a mandibular pre-prep image, a mandibular prep image, an occlusal image including a maxillary-related image and a mandibular-related image, as in the scan data 100 described below.

In the present disclosure, the prep may mean a series of preparatory processes for removing a portion of the enamel and dentin of the teeth so as to prevent interference between natural teeth and splints when performing prosthetics such as crowns and prostheses.

A “3D intraoral model” may mean a model that three-dimensionally models the oral cavity based on the raw data acquired by the scanning operation of the scanner. In addition, the “3D intraoral model” may mean a structure that is three-dimensionally modeled based on the data acquired by scanning an object such as a tooth, an impression, and an artifact. The 3D intraoral model is generated by modeling the internal structure of the oral cavity in three dimensions, and may be called a 3D scan model, a 3D model, or a tooth model. For example, a format of the 3D oral model may be one of standard triangle language (STL), OBJ, and polygon file formats, and is not limited to the above examples. In addition, the 3D intraoral model may include information such as geometric information, color, texture, and a material for a 3D shape.

In addition, the “polygon” may mean a polygon which is the smallest unit used when expressing the 3D shape of the 3D oral model. For example, the surface of the 3D oral model may be expressed as triangular polygons. For example, a polygon may be composed of at least three vertices and one face. A vertex may include information such as location, color, and normal. A mesh may be an object in a 3D space created by gathering multiple polygons. As the number of polygons representing the 3D oral model increases, the object may be expressed in detail.

The scan data 100 may include at least one of the maxillary scan data 101 and the mandibular scan data 102. Specifically, the scan data 100 may load any one of the maxillary prep data, the maxillary preparation data, the mandibular prep data, the mandibular preparation data, and the occlusal data including the maxillary-related data and the mandibular-related data.

In the present disclosure, the prep data may be data in which the enamel and dentin of the tooth are removed through the preparatory process, and the pre-prep data may be data before a portion of the enamel and dentin of the tooth are removed through the preparatory process.

The scan data 100 may include gingival region 200, maxillary tooth region data 301, and mandibular tooth region data 302, which are arranged in the maxillary scan data 101 and the mandibular scan data 102.

The electronic apparatus 20 may load at least one of the maxillary scan data 101, the mandibular scan data 102, and the occlusal data including the maxillary scan data 101 and the mandibular scan data 102.

The electronic apparatus 20 analyzes and aligns the shape of the received scan data 100 (S200). In the corresponding step, an occlusal plane and a midline for the scan data 100 are set, and the electronic apparatus 20 may automatically align the scan data 100, the maxillary scan data 101, or the mandibular scan data 102 according to the occlusal plane, and may display the left and right alignment by a midline through the display 24.

In addition, at the corresponding stage, the user may manually designate a reference point on the scan data 100 to set the front direction and the occlusal plane of the scan data 100, and align the scan data 100 along the set occlusal plane. For example, the user may select some data of the scan data 100 through the user interface device 23 at the corresponding step, and align the scan data 100 with the selected data as a reference point.

The electronic apparatus 20 sets the inner surface of the prosthesis for the aligned scan data 100 (S300).

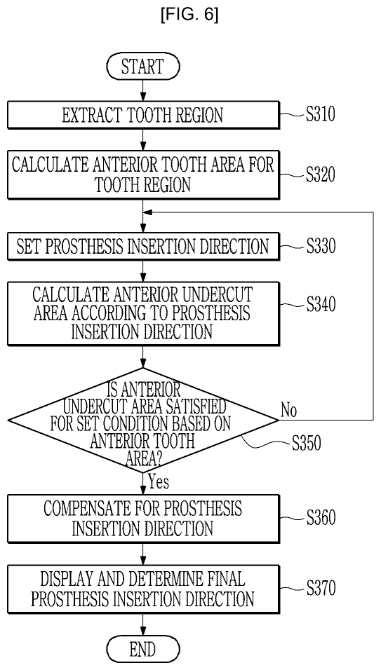

In the corresponding step, the electronic apparatus 20 may designate the direction in which the prosthesis is to be inserted by considering the undercut of the aligned scan data 100. For example, when manufacturing the prosthesis, the electronic apparatus 20 may calculate the area of the tooth region in the scan data 100, and designate the direction in which the prosthesis is to be inserted by considering the undercut and block out region according to the direction in which the prosthesis is to be inserted. The insertion efficiency and retention power of the prosthesis may be improved by designating the prosthesis insertion direction as described above. A specific description of the designation of the prosthesis insertion direction will be described later in the description of FIGS. 6 to 10.

In the present disclosure, the prosthesis means a structure inserted and arranged in the oral cavity to treat temporomandibular joint disorder, dental trauma, cavities, gum disease, etc., and includes prostheses such as a splint, a crown, an inlay, an onlay, a coping, a pontic, and a veneer, but the technical idea of the present disclosure is not limited to the above examples.

The undercut is a region where the prosthesis is caught on a patient's teeth and causes a collision when inserted, and in the present disclosure, the area of the undercut may vary depending on the prosthesis insertion direction. The undercut may occur depending on the prosthesis insertion direction as well as a black triangle, partial loss of teeth due to trauma, and tooth corrosion, which may be a factor that should be considered when manufacturing the prosthesis for the retention power of the prosthesis, ease of insertion of the prosthesis, etc

Based on the inner surface offset distance, the surface smoothness, etc., input from the user interface device 23, the electronic apparatus 20 may set the inner surface of the prothesis to be output. The inner surface offset distance may mean a separation distance in the normal direction between the scan data 100 and the inner surface of the prosthesis. The surface smoothness may mean the roughness of the inner surface of the prosthesis.

The electronic apparatus 20 specifies the outline of the prosthesis for the automatically aligned scan data 100 (S400).

Based on the buccal height, the lingual height, etc., input from the user interface device 23, the electronic apparatus 20 may designate the outline of the prosthesis to be output. For example, when manufacturing the prosthesis, the buccal height is a height of the outer wall of the tooth facing a cheek based on a lower surface of the tooth region, and for example, the buccal height may mean a height formed along the outer wall of the tooth based on the bottom surface of the tooth region of the maxillary scan data 101. The higher the buccal height, the closer the buccal outline formed is to the gingiva. The lingual height is a height of the inner wall of the tooth facing a tongue based on a bottom surface of the tooth region, and for example, the lingual height may mean a height formed along the inner wall of the tooth based on the bottom surface of the tooth region of the maxillary scan data 101. The higher the lingual height, the closer the lingual outline formed is to the gingiva.

The electronic apparatus 20 sets the outer surface of the prosthesis for the aligned scan data 100 (S500).

Based on the thickness, the surface smoothness, etc., input from the user interface device 23, the electronic apparatus 20 may designate the outer surface of the prosthesis to be output. The electronic apparatus 20 may form the 3D image for the prosthesis by setting the thickness of the prosthesis in the occlusal direction based on the predetermined occlusal thickness. For example, when manufacturing the prosthesis, the thickness may mean the thickness from the inner surface of the prosthesis in the buccal/lingual direction. The surface smoothness may mean the roughness of the outer surface of the prosthesis. The predetermined occlusal thickness may mean the maximum thickness value that the prosthesis extends in the occlusal direction.

The electronic apparatus 20 generates the 3D image data including the prosthesis through the information set and specified in steps S300 to S500 (S600). The 3D image of the generated prosthesis may be transmitted to the external device through the communication unit 21 and output to the prosthesis. The external device may be a 3D printer, but is not limited to the above example according to an exemplary embodiment.

According to an exemplary embodiment, the electronic apparatus 20 may perform steps S200 to S500 at once without an intermediate input from the user. The electronic apparatus 20 loads the scan data 100 (S100), receives inputs, such as the inner surface offset distance, the surface smoothness, the buccal height, the lingual height, and the thickness, from the user, and automatically performs steps S200 to S500 without intermediate intervention from the user to generate the 3D image data for the prosthesis (S600).

According to an exemplary embodiment, the electronic apparatus 20 may automatically perform steps S200 to S500 without user intervention by utilizing the inner surface offset distance, the surface smoothness, the buccal height, the lingual height, the thickness, etc., stored in the memory 25.

The electronic apparatus 20 may automatically perform steps S200 to S500 without the user intervention, thereby reducing the time required for the manufacturing of the prosthesis.

According to an exemplary embodiment, the electronic apparatus 20 may generate the 3D image data for the prosthesis through an inference operation of the artificial intelligence algorithm without a separate input other than the loaded scan data 100 (S600). The artificial intelligence algorithm may perform training on the prosthesis corresponding to the plurality of scan data before the inference operation, and perform the inference operation related to the 3D image data of the prosthesis suitable for the loaded scan data 100.

According to an exemplary embodiment, the electronic apparatus 20 may adjust an occlusion state or a minimum distance between arches (distance to antagonist) in each step of steps S300 to S500 through the user input regarding the occlusion state or the minimum distance between the arches between the maxillary scan data 101 and the mandibular scan data 102 in the scan data 100. During the adjustment operation, the electronic apparatus 20 may perform the calculation operation on the scan data 100 to display the occlusion state or the minimum distance between the arches together.

FIGS. 6 to 10 are diagrams illustrating a method for processing an image of the electronic apparatus for determining the prosthesis insertion direction according to an exemplary embodiment. The prosthesis includes a splint, a crown, an inlay, an onlay, a coping, a pontic, and a veneer, but the technical idea of the present disclosure is not limited to the examples.

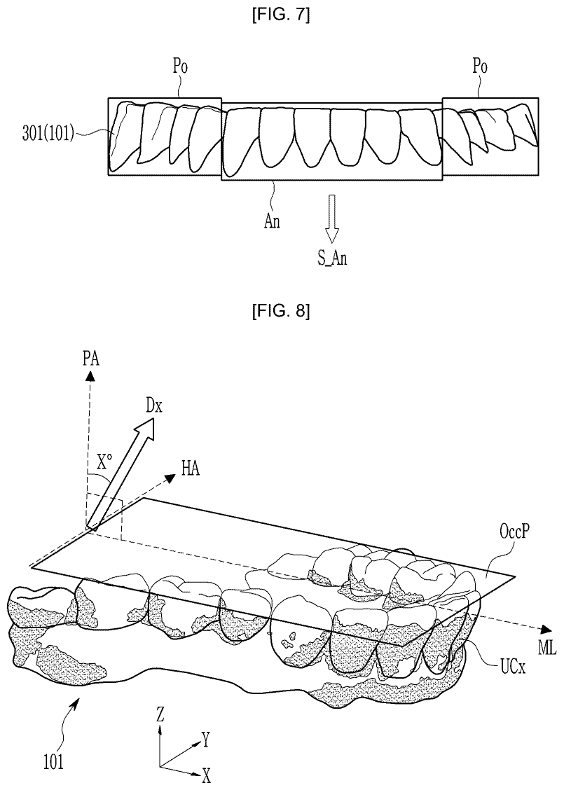

Referring to FIGS. 6 and 7, the electronic apparatus 20 extracts the tooth region from the scan data 100 (S310).

The electronic apparatus 20 may select at least one of the scan data 100 including the maxillary scan data 101 and the mandibular scan data 102 prior to extracting the tooth region. The electronic apparatus 20 may determine the final prosthesis insertion direction based on the selected scan data 100, and then the prosthesis is manufactured based on the selected scan data 100, and the manufactured prosthesis may be inserted into the oral cavity corresponding to the selected scan data 100.

The electronic apparatus 20 may extract the tooth region from the selected scan data. For example, the electronic apparatus 20 may extract the maxillary tooth region 301 from the selected maxillary scan data 101. The electronic apparatus 20 may extract the maxillary tooth region 301 by dividing the maxillary tooth region using the curvature information, the cusp information, etc., for the maxillary scan data 101, or may extract the tooth region through the object recognition artificial intelligence algorithm.

In the present disclosure, the method for processing the image of the electronic apparatus 20 is described mainly based on the application to the maxillary scan data 101, but the method for processing the image of the electronic apparatus 20 may be applied to the mandibular scan data 102 as well, without being limited thereto.

The electronic apparatus 20 calculates the anterior tooth area for the tooth region 301 (S320).

The electronic apparatus 20 may divide between an anterior An and a post Po among the extracted maxillary tooth regions 301. The electronic apparatus 20 may divide between the anterior teeth and the posterior teeth by utilizing the curvature information of the teeth, the cusp information, etc., or may divide between the anterior teeth and the posterior teeth by using the object recognition artificial intelligence algorithm. The cusp information may include the number and arrangement of cusp points where the molar in the scan data comes into contact.

The electronic apparatus 20 may calculate an anterior tooth area S_An which is the area of the divided anterior An.

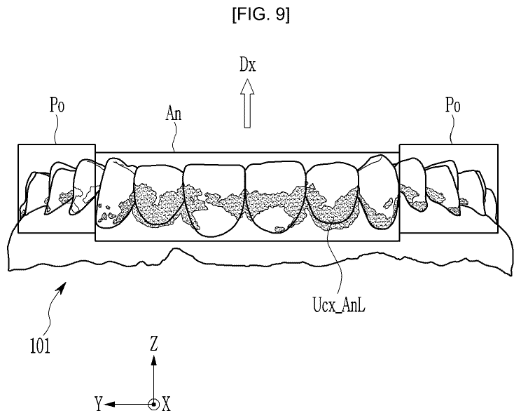

The electronic apparatus 20 sets the prosthesis insertion direction (S330). Referring additionally to FIG. 8, the electronic apparatus 20 may set a prosthesis insertion direction Dx for the maxillary scan data 101 based on the occlusal plane OccP. The electronic apparatus 20 may set the prosthesis insertion direction Dx based on the occlusal plane OccP and the midline ML of the maxillary scan data 101 set in step S200 of FIG. 3.

The electronic apparatus 20 may set the initial value of the prosthesis insertion direction Dx to the vertical direction PA of the occlusal plane OccP and set the prosthesis insertion direction Dx while rotating in the direction of the midline ML. According to an exemplary embodiment, the prosthesis insertion direction Dx is a direction extending between the vertical direction PA of the occlusal plane OccP and the direction of the midline ML, and the prosthesis insertion direction Dx and the vertical direction PA of the occlusal plane OccP may form X°. According to an exemplary embodiment, the vertical direction PA of the occlusal plane OccP and the midline ML may be orthogonal to each other, but are not limited thereto.

According to an exemplary embodiment, the electronic apparatus 20 may adjust the prosthesis insertion direction Dx by rotating around a horizontal rotation axis HA extending within the occlusal plane OccP and intersecting perpendicularly with the midline ML.

The electronic apparatus 20 calculates an anterior undercut area according to the prosthesis insertion direction Dx (S340).

Referring additionally to FIG. 9, the electronic apparatus 20 may calculate an undercut Ucx of the anterior An according to the prosthesis insertion direction Dx. According to an exemplary embodiment, the electronic apparatus 20 may calculate an anterior tooth undercut area Ucx_AnL in a labial direction for the anterior An of the maxillary scan data 101.

The electronic apparatus 20 confirms whether the anterior tooth undercut area Ucx_AnL satisfies a set condition based on the anterior tooth area (S350).

The set condition may include that a ratio of an anterior tooth area S_An to an anterior tooth undercut area Ucx_AnL according to the prosthesis insertion direction Dx is smaller than a predetermined ratio. The predetermined ratio is 0 to 0.7, preferably 0.2 to 0.5, and more preferably 0.4 to 0.5, but the technical idea of the present disclosure is not limited to the above numerical range.

By setting the initial value for the prosthesis insertion direction Dx and confirming whether the setting conditions are satisfied, the electronic apparatus 20 may reduce the amount of undercut generated during the manufacturing of the prosthesis to a certain level or less to reduce the effect of the undercut and provide the prosthesis model having uniform retention power for the plurality of oral cavities based on a predetermined standard, and set the setting conditions to set the inner surface of the splint by considering the retention power of both the anterior and post.

When the setting conditions are not satisfied, the electronic apparatus 20 performs an operation of repeating steps S330 to S350 for adjustment. The electronic apparatus 20 may set the prosthesis insertion direction Dx by rotating the prosthesis insertion direction Dx from the occlusal plane vertical direction PA to the midline ML progression direction through the repetitive operation to reduce the undercut effect. Through the repetitive operation, x° may be adjusted based on 0.1°, but is not limited thereto, and may be changed and repeated through the user input.

When the setting conditions are satisfied, the electronic apparatus 20 corrects the prosthesis insertion direction Dx (S360).

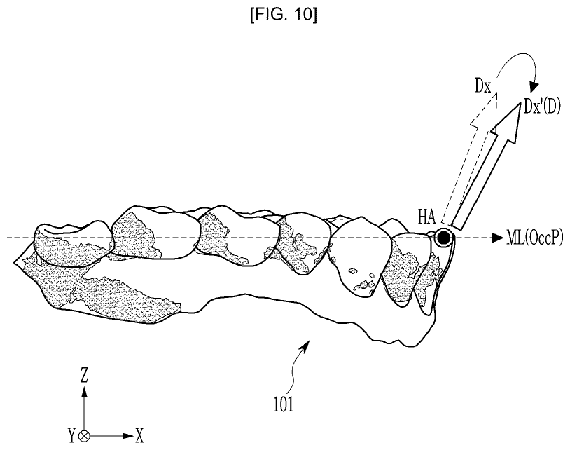

Referring additionally to FIG. 10, the electronic apparatus 20 may correct the prosthesis insertion direction Dx to the correction insertion direction Dx′. According to an exemplary embodiment, the electronic apparatus 20 may correct the insertion direction Dx to the correction insertion direction Dx′ by rotating the insertion direction Dx by a predetermined angle along the horizontal rotation axis HA, but the correction direction may vary according to an exemplary embodiment and is not limited to the above example. The predetermined angle may be 1 to 20°, preferably 5 to 10°, but is not limited thereto. In the step S360, the predetermined angle may be an average compensation angle for increasing the retention power of the prosthesis obtained from the manufacturing of the plurality of prostheses, and may be input through the user interface device 23.

According to an exemplary embodiment, the electronic apparatus 20 may perform the compensation operation for the prosthesis insertion direction Dx through the inference operation of the artificial intelligence algorithm without the separate input other than the predetermined angle (S360). The artificial intelligence algorithm may perform a learning operation for the prosthesis insertion direction corresponding to the plurality of scan data before the inference operation, and perform the inference operation related to the compensation angle for the prosthesis insertion direction.

The electronic apparatus 20 displays the compensation insertion direction Dx′ for which the compensation step was performed, and displays and determines the final prosthesis insertion direction D for the inner surface setting of the prosthesis (S370).

The electronic apparatus 20 may display the maxillary scan data 101 and the correction insertion direction Dx′ as illustrated in FIG. 10, and may display and determine the final prosthesis insertion direction D for the inner surface setting of the prosthesis.

According to an exemplary embodiment, the displayed correction insertion direction Dx′ may be manually adjusted through the input of the user interface device 23, or the prosthesis insertion direction may be calculated and recommended according to the input of the user interface device 23, and the final prosthesis insertion direction D for the inner surface setting of the prosthesis may be determined.

By determining the final prosthesis insertion direction D for the inner surface setting of the prosthesis through the steps S310 to S370, the electronic apparatus 20 according to an exemplary embodiment may provide the prosthesis model having uniform retention force for the plurality of oral cavities. In addition, the electronic apparatus 20 according to an exemplary embodiment automates the determination of the repeated block-out direction, thereby increasing the productivity of the prosthesis manufacturing.

The method for processing an image according to an exemplary embodiment of the present disclosure may be implemented in a form of program commands that may be executed through various computer means and may be recorded in a computer-readable recording medium. In addition, an exemplary embodiment of the present disclosure may be a computer-readable recording medium having recorded thereon one or more programs including commands for executing an image processing method.

The computer-readable medium may include a program command, a data file, a data structure, or the like, or a combination thereof. The program commands recorded in the computer-readable recording medium may be especially designed and configured for the present disclosure or be known to those skilled in a field of computer software. Examples of the computer-readable recording medium may include a magnetic medium such as a hard disk, a floppy disk, or a magnetic tape; an optical medium such as a compact disk read only memory (CD-ROM) or a digital versatile disk (DVD); a magneto-optical medium such as a floptical disk; and a hardware device specially configured to store and execute program commands, such as a ROM, a random access memory (RAM), a flash memory, or the like. Examples of the program commands include high-level language codes capable of being executed by a computer using an interpreter, or the like, as well as machine language codes made by a compiler.

Here, the machine-readable storage medium may be provided in a form of a non-transitory storage medium. Here, the “non-transitory storage medium” means that the storage medium is a tangible device, and does not include a signal (for example, electromagnetic waves), and the term does not distinguish between the case where data is stored semi-permanently on a storage medium and the case where data is temporarily stored thereon. For example, the “non-transitory storage medium” may include a buffer in which data is temporarily stored.

According to an exemplary embodiment, the methods according to various exemplary embodiments disclosed in the document may be included in a computer program product and provided. The computer program product may be traded as a product between a seller and a purchaser. The computer program product may be distributed in the form of a machine-readable storage medium (for example, compact disc read only memory (CD-ROM)), or may be distributed through an application store (for example, Play Store™) or may be directly distributed (for example, download or upload) between two user devices (for example, smart phones) online. In a case of the online distribution, at least some of the computer program products (for example, downloadable app) may be at least temporarily stored in a machine-readable storage medium such as a memory of a server of a manufacturer, a server of an application store, or a relay server or be temporarily created.

Although exemplary embodiments of the present disclosure have been described in detail hereinabove, the scope of the present disclosure is not limited thereto, but may include several modifications and alterations made by those skilled in the art using a basic concept of the present disclosure as defined in the claims.

1. A method for processing an image, comprising:
receiving at least one intraoral image;
calculating based on an area of at least a portion of scan data corresponding to the at least one intraoral image; and
displaying a final prosthesis insertion direction for the scan data based on the calculating.

2. The method of claim 1, wherein:
the calculating includes:
extracting a tooth region from the scan data;
calculating an anterior tooth area for the tooth region;
setting a prosthesis insertion direction for the tooth region;
calculating an anterior undercut area for an undercut region of the scan data based on the prosthesis insertion direction;
confirming whether the anterior undercut area satisfies a set condition based on the anterior tooth area; and
compensating for the prosthesis insertion direction in response to confirming whether the anterior undercut area satisfies the set condition.

3. The method of claim 2, wherein:
the calculating of the anterior undercut area includes:
separating an anterior region and a post region for the scan data; and
calculating the undercut area of the anterior region in a labial direction of the scan data based on the prosthesis insertion direction.

4. The method of claim 3, wherein:
the set condition includes that a ratio of the anterior tooth area to the anterior undercut area is smaller than a predetermined ratio.

5. The method of claim 4, wherein:
the predetermined ratio is 0 to 0.7.

6. The method of claim 2, wherein:
the calculating further includes:
when the anterior undercut area does not satisfy the set condition, repeating of setting the prosthesis insertion direction, calculating the anterior undercut area according to the prosthesis insertion direction, and confirming whether the set condition is satisfied for the anterior undercut area.

7. The method of claim 2, wherein:
the scan data includes at least one of maxillary scan data or mandibular scan data, and
the extracting of the tooth region includes selecting at least one of the maxillary scan data or the mandibular scan data and extracting the tooth region for the at least one selected data.

8. The method of claim 2, wherein:
the setting of the prosthesis insertion direction includes
adjusting around a horizontal rotation axis that extends within an occlusal plane of the scan data and intersects a midline of the scan data.

9. The method of claim 8, wherein:
the setting of the prosthesis insertion direction includes
rotating in the midline direction with a direction parallel to a vertical direction of the occlusal plane as a viewpoint.

10. The method of claim 8, wherein:
the compensating of the prosthesis insertion direction includes
rotating the prosthesis insertion direction by a predetermined angle in the labial direction.

11. An electronic apparatus, comprising:
a user interface device;
a processor; and
a memory configured to store instructions executable by the processor,
wherein the processor is configured to execute the instructions to:
receive at least one intraoral image;
calculate based on an area of at least a portion of scan data corresponding to the at least one intraoral image; and
display a final prosthesis insertion direction for the scan data based on the calculation operation.

12. The electronic apparatus of claim 11, wherein:
the calculation operation of the processor includes:
extracting a tooth region from the scan data,
calculating an anterior tooth area for the tooth region,
setting a prosthesis insertion direction for the tooth region;
calculating an anterior undercut area for an undercut region of the scan data based on the prosthesis insertion direction;
confirming whether the anterior undercut area satisfies a set condition based on the anterior tooth area; and
compensating for the prosthesis insertion direction in response to confirming whether the anterior undercut area satisfies the set condition.

13. The electronic apparatus of claim 12, wherein:
the calculating of the anterior undercut area includes:
separating an anterior region and a posterior region for the scan data; and
calculating the undercut area of the anterior region in a labial direction of the scan data based on the prosthesis insertion direction.

14. The electronic apparatus of claim 13, wherein:
the set condition includes that a ratio of the anterior tooth area to the anterior undercut area is smaller than a predetermined ratio.

15. The electronic apparatus of claim 14, wherein:
the predetermined ratio is 0 to 0.7.

16. The electronic apparatus of claim 12, wherein:
the calculation operation of the processor further includes:
when the anterior undercut area does not satisfy the set condition, repeating of setting the prosthesis insertion direction, calculating the anterior undercut area, and confirming whether the set condition is satisfied for the anterior undercut area.

17. The electronic apparatus of claim 12, wherein:
the setting of the prosthesis insertion direction includes
adjusting around a horizontal rotation axis that extends within an occlusal plane of the scan data and intersects a midline of the scan data.

18. The electronic apparatus of claim 17, wherein:
the setting of the prosthesis insertion direction includes
rotating in the midline direction with a direction parallel to a vertical direction of the occlusal plane as a viewpoint.

19. The electronic apparatus of claim 17, wherein:
the compensating of the prosthesis insertion direction includes
rotating the prosthesis insertion direction by a predetermined angle in the labial direction.

20. A computer readable storage medium including computer readable instructions,
wherein the instructions cause the computer to:
receive at least one intraoral image;
calculate based on an area of at least a portion of scan data corresponding to the at least one intraoral image; and
display a final prosthesis insertion direction for the scan data based on the calculating.
